(19) United States
(12) Patent Application Publication
(10) Pub. No.: US 2025/0071671 A1
(43) Pub. Date: Feb. 27, 2025

(54) METHOD AND APPARATUS FOR CONTROLLING SELECTION OF PLMN CANDIDATES FOR DISASTER ROAMING

(71) Applicant: SAMSUNG ELECTRONICS CO., LTD., Suwon-si, Gyeonggi-do (KR)

(72) Inventors: Lalith KUMAR, Bangalore (IN); Kailash Kumar JHA, Bangalore (IN); Aman AGARWAL, Bangalore (IN); Mahmoud WATFA, Bangalore (IN)

(21) Appl. No.: 18/725,077

(22) PCT Filed: Dec. 30, 2022
(86) PCT No.: PCT/KR2022/021743

§ 371 Date: Jun. 27, 2024

(30) Foreign Application Priority Data
Dec. 31, 2021 (IN) 202141062045
Dec. 31, 2021 (IN) 202141062056
Dec. 19, 2022 (IN) 202141062056

(51) Int. Cl. H04W 48/18; H04W 4/90; H04W 8/04; H04W 84/04

(52) U.S. Cl. CPC H04W 48/18; H04W 4/90; H04W 8/04; H04W 84/042

(57) ABSTRACT

The disclosure relates to a 5G or 6G communication system for supporting a higher data transmission rate. Embodiments herein disclose a device and methods for managing and selecting Public Land Mobile Networks (PLMNs) for disaster roaming during Minimization of Service Interruption (MINT) situations. A UE is configured for selecting one of the “list of PLMN(s) to be used in disaster condition” configured by a HPLMN/EPLMN, and “list of PLMN(s) to be used in disaster condition” configured by a VPLMN, in a disaster situation based on a UE configuration. The method discloses selection of at least one Forbidden PLMN (FPLMN) by the CE in a disaster situation, when a primary PLMN list configured by a HPLMN/EPLMN is different from at least one secondary PLMN list configured by at least one VPLMN.

### TECHNICAL FIELD

Embodiments disclosed herein relate to wireless communications, and more particularly to a device and methods of Home Public Land Mobile Network (HPLMN) control for managing and selecting PLMNs for disaster roaming during Minimization of Service Interruption (MINT) situations.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHZ” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

According to an aspect of an exemplary embodiment, there is provided a communication method in a wireless communication.

### Advantageous Effects of Invention

Aspects of the present disclosure provide an efficient communication methods in a wireless communication system.

### BRIEF DESCRIPTION OF DRAWINGS

Embodiments herein are illustrated in the accompanying drawings, through out which like reference letters indicate corresponding parts in the various figures. The embodiments herein will be better understood from the following description with reference to the drawings, in which:

FIG. 1 depicts a scenario of how to selectively control (enable/disable) disaster roaming services for a User Equipment (UE) based on location of the disaster (Home Area/Roaming Area) or based on PLMN with a disaster condition (PLMN-D), according to prior arts;

FIG. 2 depicts a process, where the UE can select and attempt registration on a PLMN for disaster roaming service when the “list of PLMN(s) to be used in disaster condition” configured by HPLMN/EHPLMN is different from the “list of PLMN(s) to be used in disaster condition” configured by VPLMN, according to prior arts;

FIG. 3 depicts a UE for selecting PLMN candidates for disaster roaming in a disaster situation, according to embodiments as disclosed herein;

FIG. 4 illustrates a method to selectively control disaster roaming services for the UE based on location of the disaster or based on PLMN with the disaster condition, according to embodiments as disclosed herein;

FIG. 5 illustrates another method to selectively control Disaster roaming services for the UE based on location of the disaster or based on the PLMN with the disaster condition, according to embodiments as disclosed herein;

FIG. 6 depicts a method of selecting and attempting registration with a PLMN for disaster roaming service in a disaster situation when the primary PLMN list configured by HPLMN/EHPLMN is different from the secondary PLMN list configured by VPLMN, according to embodiments as disclosed herein; and

FIGS. 7A and 7B illustrate sequence diagrams depicting an example process of selecting and attempting registration with a PLMN for disaster roaming service in a disaster situation when the primary PLMN list configured by HPLMN/EHPLMN is different from the secondary PLMN list configured by VPLMN, according to embodiments as disclosed herein.

FIG. 8 illustrates a structure of a UE according to an embodiment of the disclosure.

FIG. 9 illustrates a structure of a base station according to an embodiment of the disclosure.

### BEST MODE FOR CARRYING OUT THE INVENTION

Accordingly, the embodiments herein provide a method for selecting at least one Forbidden Public Land Mobile Networks (FPLMN) by a User Equipment (UE) for disaster roaming. The method discloses receiving, by the UE, a primary PLMN list and at least one secondary PLMN list to be used in a disaster condition. Subsequently, the method discloses receiving, by the UE, an indication for indicating whether the UE is allowed to use the secondary PLMN list in the disaster condition. The indication is configured by a Home PLMN (HPLMN) or an Equivalent HPLMN (EHPLMN). Thereafter, the method discloses selecting, by the UE, the FPLMN/Next Generation-Radio Access Network (NG-RAN) combination from one of the primary PLMN list and the secondary PLMN list based on the received indication.

Accordingly, the embodiments herein provide a UE for selecting at least one Forbidden Public Land Mobile Networks (FPLMN) for disaster roaming. The UE is configured to receive a primary PLMN list and at least one secondary PLMN list to be used in a disaster condition, receive an indication for indicating whether the UE is allowed to use the secondary PLMN list in the disaster condition, and select at least one FPLMN/Next Generation-Radio Access Network (NG-RAN) combination from one of the primary PLMN list and the secondary PLMN list based on the received indication.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Mode for the Invention

This application is based on and derives the benefit of Indian Provisional Applications 202141062056 and 202141062045, the contents of which are incorporated herein by reference.

Before undertaking the description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Definitions for other certain words and phrases are provided throughout this patent document. Those of ordinary skill in the art should understand that in many if not most instances, such definitions apply to prior as well as future uses of such defined words and phrases.

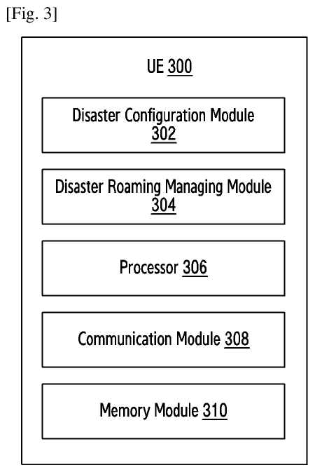

The embodiments herein achieve a device and methods for selecting Public Land Mobile Network (PLMN) candidates for disaster roaming. Referring now to the drawings, and more particularly to FIGS. 3 through 7, where similar reference characters denote corresponding features consistently throughout the figures, there are shown embodiments.

The following abbreviations and definitions have been used herein:

Available PLMN—PLMN(s) in a given area which is/are broadcasting capability to provide wireless communication services to a User Equipment (UE).

Home PLMN (HPLMN)—This is a PLMN where the Mobile Country Code (MCC) and Mobile Network Code (MNC) of a PLMN identity match the MCC and MNC of an International Mobile Subscriber Identity (IMSI).

Equivalent HPLMN (EHPLMN)—Any of the PLMN entries are contained in the EHPLMN list.

EHPLMN list—To allow provision for multiple HPLMN codes, and PLMN codes that are present within this list shall replace the HPLMN codes derived from the IMSI for PLMN selection purposes. This list is stored in the Universal Subscriber Identity Module (USIM) and is known as the EHPLMN list. The EHPLMN list may also contain the HPLMN codes derived from the IMSI. If a HPLMN code derived from the IMSI is not present in the EHPLMN list then the HPLMN shall be treated as a Visited PLMN (VPLMN) for PLMN selection purposes.

Disaster Condition—This is the condition that a government decides when to initiate and terminate, for example, a natural disaster. When this condition applies, users may have an opportunity to mitigate service interruptions and failures.

Disaster Roaming—This is a special roaming policy that applies during a Disaster Condition.

PLMN with Disaster Condition—A PLMN to which a disaster condition applies.

The terms disaster situation and disaster condition are used interchangeably hereafter in the entire description and have the same meaning.

The purpose of Minimization of Service Interruption (MINT) is to minimize interruption of service to users, when the network to which the users are subscribed, cannot provide service due to a disaster (for example, a fire). The interruption of service can be minimized by enabling the users to obtain service on other networks (which are actually forbidden for the UE in normal situation), while at the same time protecting the other networks from congestion.

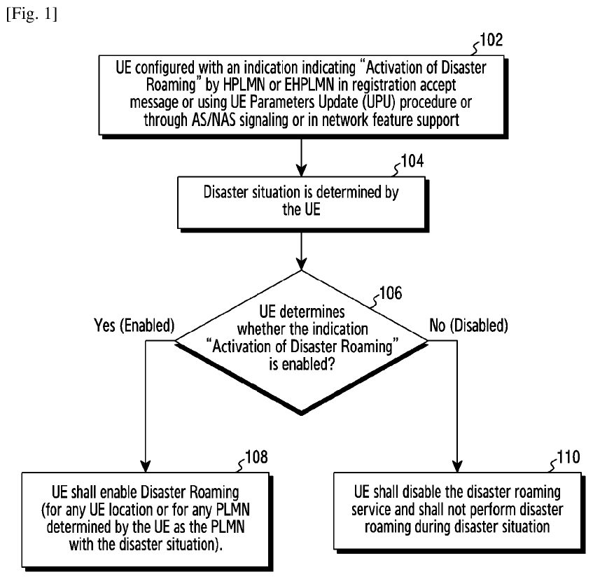

For example, consider that, Public Land Mobile Network (PLMN ‘D’) is subject to disaster and PLMN ‘A’ is alive and not subject to disaster. FIG. 1 depicts a scenario of how to selectively control (enable/disable) disaster roaming services for a User Equipment (UE) based on location of the disaster (Home Area/Roaming Area) or based on the PLMN with a disaster condition (PLMN-D).

As depicted in step 102, the UE is configured with an indication indicating “Activation of Disaster Roaming”, by a Home PLMN (HPLMN) or an Equivalent Home PLMN (EHPLMN) in a registration accept message or using a UE Parameters Update (UPU) procedure or through an access stratum (AS)/Non-access stratum (NAS) signalling or in a network feature support. Later, a disaster situation is determined by the UE, as depicted in step 104. Thereafter, the UE determines whether the indication “Activation of Disaster Roaming” is enabled, as depicted in step 106. If the “Activation of Disaster Roaming” is enabled, then the UE shall enable disaster roaming for any UE location or for any PLMN determined by the UE as the PLMN with the disaster situation, as depicted in step 108. The UE can enable the disaster roaming for all the UE location/PLMN with disaster condition without a selective preference for a particular UE location/without a selective preference for a particular PLMN with disaster condition. If the “Activation of Disaster Roaming” is disabled, then the UE shall disable the disaster roaming service and shall not perform disaster roaming during the disaster situation, as depicted in step 110. The UE can disable the disaster roaming for all the UE location/PLMN with disaster condition without a selective preference for a particular UE Location/without a selective preference for a particular PLMN with disaster condition.

For example, in a scenario, where a User Equipment (UE) supports disaster roaming or Minimization of Service Interruption (MINT), an optional “list of PLMN(s) to be used in disaster condition′” may be pre-configured in a Universal Subscriber Identity Module (USIM) or provided by the (HPLMN) or the EHPLMN. The “list of PLMN(s) to be used in disaster condition′” can be provided by the HPLMN or the EHPLMN during and after a successful registration procedure over 3GPP access or non-3GPP access via a registration request procedure or a UE configuration update procedure. While roaming (i.e., not in the country of the HPLMN), the registered PLMN in a roaming area, i.e., a Visited PLMN (VPLMN) may provide the “list of PLMN(s) to be used in disaster condition” during and after a successful registration procedure to the UE via a registration request procedure or a UE configuration update procedure. The list provided by the VPLMN shall not alter the list provided by the HPLMN or the EHPLMN.

However, the UE may have two different lists: “list of PLMN(s) to be used in disaster condition” configured by the HPLMN or the EHPLMN and the “list of PLMN(s) to be used in disaster condition” configured by the VPLMN (while roaming). The PLMN(s) listed in the above lists may be different or may be listed in a different priority order. For example, the HPLMN or the EHPLMN may configure the UE with the “list of PLMN(s) to be used in disaster condition” with PLMN(s) P3, P2 and P1 (in priority order P3>P2>P1) and the VPLMN may configure the UE with “list of PLMN(s) to be used in disaster condition” with PLMN(s) P1, P2 and P3 (in priority order P1>P2>P3).

Consider a case, when the UE determines a PLMN with a disaster condition and the PLMN is the VPLMN, where in such a condition the UE uses the list configured by the VPLMN. Also, charging and pricing for disaster roaming services provided by each PLMN(s) listed in “list of PLMN(s) to be used in disaster condition” might be different. Further, the PLMN(s) or the order of the PLMN(s) listed in the “list of PLMN(s) to be used in disaster condition” configured by the HPLMN/EHPLMN might be different from the PLMN(s) or the order of the PLMN(s) listed in the “list of PLMN(s) to be used in disaster condition” configured by the VPLMN. Currently, the HPLMN does not control which list(s) shall the UE prefer and use in a disaster situation for better cost management and better pricing.

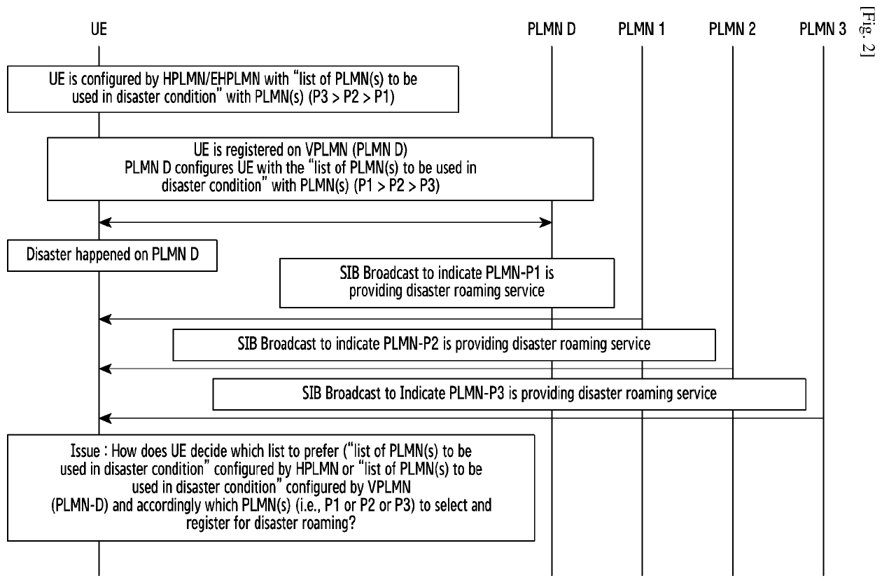

FIG. 2 depicts an example flow process, where UE is configured with a “list of PLMN(s) to be used in disaster condition”, by the HPLMN/EHPLMN, and the PLMN(s) are P3, P2, P1 (in priority order i.e., P3>P2>P1). The UE is further registered on the VPLMN (i.e., PLMN D), where the PLMN D configures the UE with the “list of PLMN(s) to be used in disaster condition” with PLMN(s) P1, P2, P3 (in priority order i.e., (P1>P2>P3). As indicated in FIG. 1, the PLMN(s) P1, P2, P3 indicate their availability of disaster roaming services to the UE through a System Information Blocks (SIB) broadcast.

When the disaster situation has occurred on the PLMN D, if PLMN(s) P1, P2 and P3 are available and providing disaster roaming services, the UE might select and attempt registration on PLMN P1 for disaster roaming service based on the priority of PLMN P1 in the “list of PLMN(s) to be used in disaster condition” configured by the VPLMN. However, this is not desirable as there are other PLMN(s) available and providing disaster roaming services (PLMN(s) P3 and P2) which may have more priority over P1 as present in the “list of PLMN(s) to be used in disaster condition” configured by the HPLMN. Hence, there is an issue of which PLMN(s) shall the UE select and attempt registration for disaster roaming service in a disaster situation when the “list of PLMN(s) to be used in disaster condition” configured by the HPLMN/EHPLMN is different from the “list of PLMN(s) to be used in disaster condition” configured by the VPLMN.

The principal object of embodiments herein is to disclose a device and methods for managing disaster roaming services during Minimization of Service Interruption (MINT) situation.

Another object of embodiments herein is to disclose a device and methods for selecting one of the “list of PLMN(s) to be used in disaster condition” configured by a HPLMN/EPLMN, and “list of PLMN(s) to be used in disaster condition” configured by a VPLMN, in a disaster situation based on a UE configuration.

Another object of embodiments herein is to disclose a method for selecting at least one Forbidden PLMN (FPLMN) by a UE in a disaster situation, when the “list of PLMN(s) to be used in disaster condition” configured by a HPLMN/EPLMN is different from the “list of PLMN(s) to be used in disaster condition” configured by a VPLMN.

FIG. 3 depicts a UE 300 for selecting PLMN candidates for disaster roaming in a disaster situation. The UE 300 can be configured for selecting at least one Forbidden PLMN (FPLMN) for disaster roaming. The UE 300 comprises a disaster configuration module 302, a disaster roaming managing module 304, a processor 306, a communication module 308, and a memory module 310.

In an embodiment herein, the disaster configuration module 302 can enable configuration of a UE supporting Disaster Roaming by a HPLMN or a EHPLMN in a registration accept message or using a UE Parameters Update (UPU) procedure or through an access stratum (AS)/Non-access stratum (NAS) procedure or any NAS/AS signalling message or in 5G Network Feature Support, with an indication (flag) for example, “Selective Activation of Disaster Roaming”, “Activation of Disaster Roaming for Home Area or HPLMN Area only”, and so on.

In an embodiment herein, the disaster configuration module 302 can enable configuration of a UE supporting Disaster Roaming by the HPLMN or the EHPLMN with an indication to indicate whether the UE 300 is allowed to use a “list of PLMN(s) to be used in disaster condition” configured by any other PLMN(s) i.e. VPLMN apart from the HPLMN or the EHPLMN (such as Visited PLMN (VPLMN)) in a disaster situation. The “list of PLMN(s) to be used in disaster condition” can comprise a primary PLMN list configured by the HPLMN and at least one secondary PLMN list configured by at least one VPLMN. The disaster configuration module 302 can enable configuration of the primary PLMN list, at least one secondary PLMN list and the indication in one of a USIM and a mobile equipment (ME) of the UE 300. The primary PLMN list and the secondary PLMN list can be configured using one of a registration procedure and a UE configuration update procedure over a 3GPP access or a non-3GPP access. The indication may indicate applicability of at least one secondary PLMN list to be used in the disaster condition provided by at least one VPLMN.

In an embodiment herein, the primary PLMN list is on at least one list of PLMN(s) to be used in the disaster condition stored in the ME. The list of PLMN(s) of the primary PLMN list can be associated with a PLMN ID of the HPLMN or the EHPLMN as those are configured by the HPLMN or the EHPLMN in the UE 300 respectively. The secondary PLMN list is on at least one list of PLMN(s) to be used in the disaster condition. The list of PLMN(s) of the secondary PLMN list is associated with a PLMN ID of at least one VPLMN configured by the VPLMN in the UE 300.

In an embodiment herein, the indication can be configured by the HPLMN or EHPLMN and can be stored either in the USIM or in ME of the UE 300. The indication can be configured by a NAS procedure using one of a registration procedure, a UPU procedure and a downlink (DL) NAS transport procedure etc. The indication can be provided to the UE 300 by any PLMN (not restricted to HPLMN/EHPLMN) in any of the AS or NAS signalling message.

In an embodiment herein, the disaster configuration module 302 can enable configuration of the indication by a VPLMN in the UE 300. The indication can be stored in the ME after switch OFF and switch ON conditions i.e., power cycle. The indication can be maintained by the UE 300 till a new USIM is inserted in the UE 300. The indication can be cleared or removed by the UE 300 if the USIM is removed and reinserted. The indication can be stored or maintained by the UE 300 if the USIM is removed and re-inserted.

The indication can be a 2-bit flag and is defined in Table 1. Table 1 provides bits value and decimal value for different conditions set for the indication “Selective Activation of Disaster Roaming”.

TABLE 1
Flag: Selective Activation of Roaming

| Bits | Decimal | |
|---|---|---|
| Value | Value | Definition |
| 00 | 0 | Disaster Roaming is disabled |
| 01 | 1 | Disaster Roaming is enabled for |
| | | HPLMN/EHPLMN (i.e., when PLMN with |
| | | disaster condition (PLMN-D) is |
| | | HPLMN/EHPLMN of the UE) |
| 10 | 2 | Disaster Roaming is enabled for PLMN(s) |
| | | with disaster condition (PLMN-D) having |
| | | MCC same as the MCC of the |
| | | HPLMN/EHPLMN of the UE (for example, |
| | | UE is in the same country of the |
| | | HPLMN/EHPLMN) |
| 11 | 3 | Disaster Roaming is enabled for all |
| | | location/PLMN(s) (i.e., for any PLMN with |
| | | disaster condition (for example, any PLMN- |
| | | D) as determined by the UE) |

In an embodiment herein, the value (bits value and decimal value) of the indication “Selective Activation of Disaster Roaming” or “Activation of Disaster Roaming for Home Area or HPLMN Area only” can be stored in the UE 300 (USIM/ME). When the UE 300 determines that the value of the indication “Selective Activation of Disaster Roaming” or “Activation of Disaster Roaming for Home Area or HPLMN Area only” or “UE is allowed to use to ‘list of PLMN(s) to be used in disaster condition’ configured by any other PLMN(s) apart from the HPLMN or the EHPLMN” is set or changed, the disaster configuration module 302 can store or change the value of the indication stored in the UE 300 (USIM/ME) (if already available) and selectively enable/disable the Disaster roaming service based on the value of the indication. If the value of the indication “list of PLMN(s) to be used in disaster condition” is set to disabled or FALSE, then if the disaster configuration module 302 receives the “list of PLMN(s) to be used in disaster condition” from the VPLMN, the disaster configuration module 302 ignores this list and optionally does not store it in the ME or USIM.

In an embodiment herein, on determining that a disaster situation has occurred, the disaster roaming managing module 304 can verify data of indication, and manage disaster roaming service to the UE 300 based on the indication. The disaster roaming managing module 304 can check if the indication is enabled (For example, TRUE) or is disabled (For example, FALSE). The disaster roaming managing module 304 can determine if the PLMN with the disaster condition (PLMN-D) is either the HPLMN or the EHPLMN or any of the PLMN(s) in the EHPLMN list. The disaster roaming managing module 304 can determine if the MCC of the PLMN with the disaster condition (PLMN-D) is same as the MCC of either the HPLMN or the EHPLMN or any of the PLMN(s) in the EHPLMN list of the UE 300. The disaster roaming managing module 304 can select at least one FPLMN/Next Generation-Radio Access Network (NG-RAN) combination from one of the configured primary PLMN list and the secondary PLMN list from the disaster configuration module 302 based on the indication of applicability of at least one list of PLMN(s) to be used in the disaster condition.

The disaster roaming managing module 304 can verify whether the indication indicating “Selective Activation of Disaster Roaming” is configured in the UE 300 or not. The disaster roaming managing module 304 can verify the configuration of the indication from the disaster configuration module 302. The disaster roaming managing module 304 can further verify the value of the indication “Selective Activation of Roaming” which is stored in the UE 300 (USIM or ME).

For example, when the disaster roaming managing module 304 determines that a disaster situation has occurred, the disaster roaming managing module 304 shall first determine whether the indication indicating “Selective Activation of Disaster Roaming” has been configured in the UE 300 or not and the value of the indication “Selective Activation of Roaming” stored in the UE 300.

If the indication “Selective Activation of Disaster Roaming” is either present in the UE 300 or is configured by the HPLMN (or the EHPLMN) in the UE 300 and the value of the indication is 0 (or bits value 00), then the disaster roaming managing module 304 shall disable the disaster roaming service and shall not perform disaster roaming during the disaster situation. The disaster roaming managing module 304 shall enable the UE 300 to enter a limited service state during the disaster situation, in response to determining that the disaster roaming is disabled in the UE 300.

If the indication “Selective Activation of Disaster Roaming” is either present in the UE 300 or is configured by the HPLMN (or the EHPLMN) in the UE 300 and the value of the indication is 1 (or bits value 01), then the disaster roaming managing module 304 shall enable the disaster roaming service to the UE 300 only if the disaster roaming managing module 304 determines that the PLMN with the disaster condition (PLMN-D) is either the HPLMN or the EHPLMN or any of the PLMN(s) in the EHPLMN list of the UE 300. For example, when the disaster roaming managing module 304 determines that the disaster situation has occurred, the disaster roaming managing module 304 shall perform disaster roaming registration only if the PLMN with the disaster condition (PLMN-D) is either the HPLMN or the EHPLMN or any of the PLMN(s) in the EHPLMN list of the UE 300. The disaster roaming managing module 304 shall not perform disaster roaming during the disaster situation and shall enter the limited service state if the PLMN with the disaster condition (PLMN-D) is neither the HPLMN nor the EHPLMN nor any of the PLMN(s) in the EHPLMN list of the UE 300 and if the value of the indication “Selective Activation of Disaster Roaming” is determined/stored as 1 (01) in the UE 300.

If the indication “Selective Activation of Disaster Roaming” is either present in the UE 300 or is configured by the HPLMN (or the EHPLMN) in the UE 300 and the value of the indication is 2 (or bits value 10), then the disaster roaming managing module 304 shall enable the disaster roaming service only if the MCC of the PLMN with the disaster condition (PLMN-D) is same as the MCC of either the HPLMN or the EHPLMN or any of the PLMN(s) in the EHPLMN list of the UE 300, i.e., when the UE 300 has faced disaster in the same country of the HPLMN/EHPLMN. When the disaster roaming managing module 304 determines that the disaster situation has occurred, the disaster roaming managing module 304 shall perform disaster roaming registration only if the MCC of the PLMN with the disaster condition (PLMN-D) is the same as the MCC of either the HPLMN or the EHPLMN or any of the PLMN(s) in the EHPLMN list of the UE 300. The disaster roaming managing module 304 shall not perform disaster roaming during the disaster situation and shall enter the limited service state if the MCC of the PLMN with the disaster condition (PLMN-D) is not same as the MCC of the HPLMN or not same as the MCC of the PLMN(s) in the EHPLMN list of the UE 300 (i.e., when the UE 300 is in a different country and not the same country as the HPLMN/EHPLMN) and if the value of the indication “Selective Activation of Disaster Roaming” is determined/stored as 2 (or bits value 10) in the UE 300.

If the indication “Selective Activation of Disaster Roaming” is either present in the UE 300 or is configured by the HPLMN (or the EHPLMN) in the UE 300 and the value of the indication is 3 (or bits value 11), then the disaster roaming managing module 304 shall enable the disaster roaming service (for any UE location or for any PLMN determined by the UE 300 as the PLMN with the disaster situation (i.e., for any PLMN-D)). When the disaster roaming managing module 304 determines that the disaster situation has occurred, the disaster roaming managing module 304 shall perform disaster roaming registration to obtain disaster roaming services if the value of the indication “Selective Activation of Disaster Roaming” is determined/stored as 3 (or bits value 11) in the UE 300.

In an embodiment herein, the disaster roaming managing module 304 determines whether the indication has been configured by the HPLMN (or the EHPLMN) or not, and then determines the value of the indication (the indication has been configured). For example, if the disaster roaming managing module 304 identifies that the indication is not configured by the HPLMN (or the EHPLMN) in the UE 300, then the disaster roaming managing module 304 determines the indication value as disabled or FALSE or 0 (or bits value 00). In another embodiment herein, if the disaster roaming managing module 304 identifies that the indication is not configured by the HPLMN (or the EHPLMN) in the UE 300, then the disaster roaming managing module 304 determines the indication value as enabled or TRUE or any of 1 (bits value 01) or 2 (bits value 10) or 3 (bits value 11).

In an embodiment herein, if the indication is not stored or maintained in the UE 300 (cither in ME or in the USIM), then the disaster roaming managing module 304 determines that the indication value as disabled or FALSE or 0 (or bits value 00). In another embodiment herein, if the indication is not stored or maintained in the UE 300, then the disaster roaming managing module 304 determines that the indication value as enabled or TRUE or any of 1 (bits value 01) or 2 (bits value 10) or 3 (bits value 11).

In an embodiment herein, if the indication “Activation of Disaster Roaming for Home Area or HPLMN Area only” is either present in the UE 300 (in USIM or ME) or is configured by the HPLMN (or the EHPLMN) in the UE 300 and the value of the indication is disabled or indicated as FALSE, then the disaster roaming managing module 304 shall disable the disaster roaming service and shall not perform disaster roaming during the disaster situation. The disaster roaming managing module 304 shall enable the UE 300 to enter the limited service state during the disaster situation, in response to determining that the disaster roaming has been disabled in the UE 300.

In an embodiment herein, if the indication “Activation of Disaster Roaming for Home Area or HPLMN Area only” is either present in the UE 300 (in USIM or ME) or is configured by the HPLMN (or the EHPLMN) in the UE 300 and the value of the indication is enabled or indicated as TRUE, then the disaster roaming managing module 304 shall enable the disaster roaming service only if the disaster roaming managing module 304 determines that the UE 300 is in the Home Area or the HPLMN Area. When the disaster roaming managing module 304 determines that the disaster situation has occurred, the disaster roaming managing module 304 shall perform disaster roaming registration only if the UE 300 is in the Home Area or the HPLMN Area. The disaster roaming managing module 304 shall not perform disaster roaming during a disaster situation and shall enter the limited service state, if the disaster roaming managing module 304 determines that the UE is not in the Home Area or not in the HPLMN Area and if the value of the indication “Activation of Disaster Roaming for Home Area or HPLMN Area only” is determined/stored as enabled or TRUE.

In an embodiment herein, if the disaster roaming managing module 304 determines that the disaster situation has occurred, the disaster roaming managing module 304 shall first determine if the indication indicating “UE is allowed to use to ‘list of PLMN(s) to be used in disaster condition’ configured by any other PLMN(s) apart from the HPLMN or the EHPLMN” is enabled (For example, TRUE) or is disabled (For example, FALSE).

For example, the configuration of the UE 300 is:
“list of PLMN(s) to be used in disaster condition” configured by the HPLMN (or the EHPLMN): P3, P2, P1 (in priority order i.e., P3>P2>P1); and
“list of PLMN(s) to be used in disaster condition” configured by the VPLMN: P1, P2, P3 (in priority order i.e., P1>P2>P3).

When a disaster situation has occurred, if PLMN(s) P1, P2 and P3 are available and providing disaster roaming services, the disaster roaming managing module 304 shall first determine if the indication indicating “UE is allowed to use to ‘list of PLMN(s) to be used in disaster condition’ configured by any other PLMN(s) (i.e. VPLMNs) apart from the HPLMN or the EHPLMN” is enabled (for example, is TRUE) or is disabled (for example, is FALSE).

If the indication indicating “UE is allowed to use to ‘list of PLMN(s) to be used in disaster condition’ configured by any other PLMN(s) or VPLMN(s) i.e., apart from the HPLMN or the EHPLMN” is enabled or indicated as TRUE, the disaster roaming managing module 304 shall prefer or use the “list of PLMN(s) to be used in disaster condition” configured by the PLMN (apart from the HPLMN or the EHPLMN) on which disaster condition is determined (for example, VPLMN) to select and attempt registration on FPLMN/access technology combination for disaster roaming when disaster situation has occurred. In this case, the disaster roaming managing module 304 shall select and attempt registration on PLMN P1 for disaster roaming service based on the priority of PLMN P1 in the “list of PLMN(s) to be used in disaster condition” configured by the VPLMN when VPLMN is the PLMN with disaster condition. The disaster roaming managing module 304 can select at least one FPLMN/NG-RAN combination for disaster roaming from the secondary PLMN list associated with a PLMN ID of the determined PLMN with the disaster condition, wherein the PLMN list has been ordered based on the at least one secondary PLMN list in response to determining that indication is set to TRUE. The disaster roaming managing module 304 can select at least one FPLMN/NG-RAN combination for disaster roaming from the primary PLMN list associated with a PLMN ID of the HPLMN or the EHPLMN, wherein the PLMN list has been ordered based on the primary PLMN list in response to determining that the secondary PLMN list associated with the PLMN ID of the determined PLMN with the disaster condition is not configured.

In this embodiment, the indication names below are used interchangeably and have the same meaning.
a) “UE is allowed to use to ‘list of PLMN(s) to be used in disaster condition’ configured by any other PLMN(s) or VPLMN(s) i.e., apart from the HPLMN or the EHPLMN”;
b) “‘applicability of “lists of PLMN(s) to be used in disaster condition” provided by a VPLMN’, provided by the HPLMN”; or
c) “whether the UE (300) is allowed to use the at least one secondary PLMN list in the disaster condition”.

If the indication indicating “UE is allowed to use to ‘list of PLMN(s) to be used in disaster condition’ configured by any other PLMN(s) or VPLMN(s) i.e., apart from the HPLMN or the EHPLMN” is disabled or indicated as FALSE, the disaster roaming managing module 304 can select at least one FPLMN/NG-RAN combination for disaster roaming from the primary PLMN list associated with the PLMN ID of the HPLMN or the EHPLMN, wherein the PLMN list has been ordered based on the primary PLMN list in response for disaster roaming when disaster situation has occurred. In this case, the disaster roaming managing module 304 shall select and attempt registration on PLMN P3 for disaster roaming service based on the priority of PLMN P3 in the “list of PLMN(s) to be used in disaster condition” configured by the HPLMN (or the EHPLMN).

In an embodiment herein, if the indication indicating “UE is allowed to use to ‘list of PLMN(s) to be used in disaster condition’ configured by any other PLMN(s) apart from the HPLMN or the EHPLMN” is either not present in the UE 300 or disabled or has been indicated as FALSE, then:

a) When the disaster roaming managing module 304 determines that the disaster situation has occurred, the disaster roaming managing module 304 shall select and attempt registration on other PLMN/access technology combination providing disaster roaming service (PLMN-A), if available in the following order:

i) PLMN/NG-RAN combination for disaster roaming with a PLMN in the “list of PLMN(s) to be used in disaster condition” configured by the HPLMN (or the EHPLMN), wherein the PLMN list has been ordered based on the “list of PLMN(s) to be used in disaster condition” configured by the HPLMN (or the EHPLMN).

ii) PLMN/NG-RAN combination for disaster roaming with a PLMN in the “list of PLMN(s) to be used in disaster condition” configured by the PLMN (apart from the HPLMN or the EHPLMN) on which disaster condition is determined (for example, VPLMN), wherein the PLMN list has been ordered based on the “list of PLMN(s) to be used in disaster condition” configured by the PLMN (apart from the HPLMN or the EHPLMN) on which disaster condition is determined (for example, VPLMN).

iii) PLMN/NG-RAN combination for other forbidden PLMNs for disaster roaming, in random order.

b) In yet another embodiment, when the disaster roaming managing module 304 determines that the disaster situation has occurred, the disaster roaming managing module 304 shall select and attempt registration on other PLMN/access technology combination providing disaster roaming service (PLMN-A), if available in the following order:

i) PLMN/NG-RAN combination for disaster roaming with a PLMN in the “list of PLMN(s) to be used in disaster condition” configured by the HPLMN (or the EHPLMN), wherein the PLMN list has been ordered based on the “list of PLMN(s) to be used in disaster condition” configured by the HPLMN (or the EHPLMN).

ii) The disaster roaming managing module 304 shall ignore or not select any of the PLMN/NG-RAN combination for disaster roaming with a PLMN not in the “list of PLMN(s) to be used in disaster condition” configured by the HPLMN (or the EHPLMN). The UE 300 shall also ignore or not select any of the PLMN/NG-RAN combination for disaster roaming with a PLMN in the “list of PLMN(s) to be used in disaster condition” configured by the PLMN (apart from the HPLMN or the EHPLMN) on which disaster condition is determined (for example, VPLMN) (if available).

c) In yet another embodiment, when the disaster roaming managing module 304 determines that the disaster situation has occurred, the disaster roaming managing module 304 shall select and attempt registration on other PLMN/access technology combination providing disaster roaming service (PLMN-A), if available in the following order:

i) PLMN/NG-RAN combination for disaster roaming with a PLMN in the “list of PLMN(s) to be used in disaster condition” configured by the HPLMN (or the EHPLMN), wherein the PLMN list has been ordered based on the “list of PLMN(s) to be used in disaster condition” configured by the HPLMN (or the EHPLMN).

ii) The disaster roaming managing module 304 shall ignore the “list of PLMN(s) to be used in disaster condition” configured by the VPLMN (if available) and select PLMN/NG-RAN combination for other forbidden PLMNs for disaster roaming, in random order.

d) The disaster roaming managing module 304 shall select any of the above approaches (a) or (b) or (c) in random order or based on UE implementation.

In an embodiment herein, the term disaster roaming managing module 304 can disable the disaster roaming service; i.e., the UE 300 shall not select any of the PLMN(s) in the Forbidden PLMN (FPLMN) list and the UE 300 shall not attempt the registration procedure on any of the PLMN(s) in the FPLMN List to receive disaster roaming service in a disaster situation. In an embodiment herein, the term disaster roaming managing module 304 can enable the disaster roaming service; i.e., the UE 300 is allowed to select any of the PLMN(s) in the FPLMN List and attempt the registration procedure on any of the PLMN(s) in the FPLMN List to receive the disaster roaming service in a disaster situation.

In an embodiment herein, the processor 306 can be configured to process and execute data of plurality of modules of the UE 300. The processor 306 may comprise one or more of microprocessors, circuits, and other hardware configured for processing. The processor 306 can be configured to execute instructions stored in the memory module 310. The processor 306 can be at least one of a single processer, a plurality of processors, multiple homogeneous or heterogeneous cores, multiple Central Processing Units (CPUs) of different kinds, microcontrollers, special media, and other accelerators. The processor 306 may be an application processor (AP), a graphics-only processing unit such as a graphics processing unit (GPU), a visual processing unit (VPU), and/or an Artificial Intelligence (AI)-dedicated processor such as a neural processing unit (NPU).

In an embodiment herein, the UE 300 can communicate with the PLMNs via the communication module 308. The communication module 308 may be in the form of either a wired network, a wireless network, or a combination thereof. The wired and wireless communication networks may comprise but not limited to, GPS, GSM, LAN, Wi-Fi compatibility, Bluetooth low energy as well as NFC. The wireless communication may further comprise one or more of Bluetooth (registered trademark), ZigBee (registered trademark), a short-range wireless communication such as UWB, a medium-range wireless communication such as Wi-Fi (registered trademark) or a long-range wireless communication such as 3G/4G or WiMAX (registered trademark), according to the usage environment.

In an embodiment herein, the memory module 310 may comprise one or more volatile and non-volatile memory components which are capable of storing data and instructions of the modules of the UE 300 to be executed. Examples of the memory module 310 can be, but not limited to, NAND, embedded Multi Media Card (eMMC), Secure Digital (SD) cards, Universal Serial Bus (USB), Serial Advanced Technology Attachment (SATA), solid-state drive (SSD), and so on. The memory module 310 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 310 may, in some examples, be considered a non-transitory storage medium. The term “non-transitory” may indicate that the storage medium is not embodied in a carrier wave or a propagated signal. However, the term “non-transitory” should not be interpreted to mean that the memory module 310 is non-movable. In certain examples, a non-transitory storage medium may store data that can, over time, change (e.g., in Random Access Memory (RAM) or cache).

FIG. 3 shows example modules of the UE 300, but it is to be understood that other embodiments are not limited thereon. In other embodiments, the UE 300 may include less or more number of modules. Further, the labels or names of the modules are used only for illustrative purpose and does not limit the scope of the invention. One or more modules can be combined together to perform same or substantially similar function in the UE 300. Additionally, an operation of the Disaster configuration module (302) and the Disaster Roaming Managing Module (304) may operate by the processor (306).

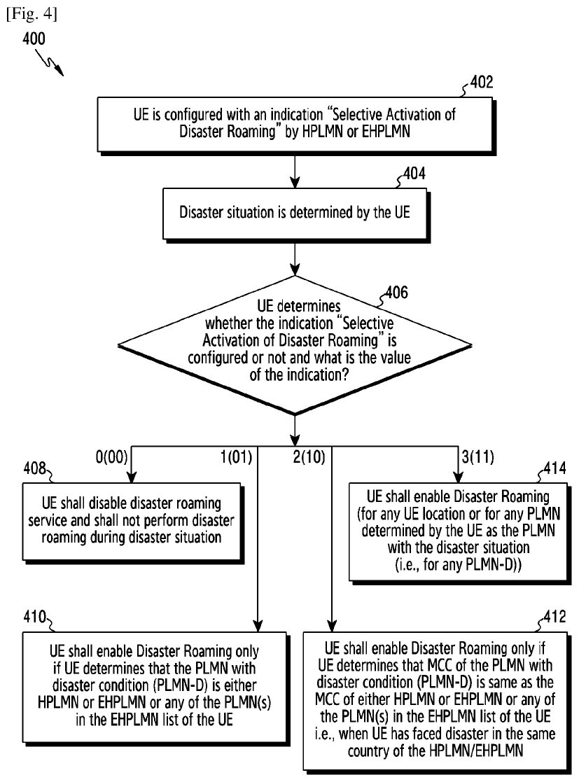

FIG. 4 illustrates a method 400 to selectively control (enable/disable) disaster roaming services for the UE 300 based on location of the disaster (Home Area/Roaming Area) or based on PLMN with the disaster condition (PLMN-D). As depicted in step 402, the UE 300 is configured with an indication indicating “Selective Activation of Disaster Roaming” by the HPLMN or the EHPLMN using one of a registration procedure, a UPU procedure and a downlink (DL) NAS transport procedure. The indication is configured by using the disaster configuration module 302.

Later, a disaster situation is determined by the disaster roaming managing module 304 of the UE 300, as depicted in step 404. Subsequently, the disaster roaming managing module 304 determines whether the indication “Selective Activation of Disaster Roaming” is configured or not and what is the value of the indication “Selective Activation of Disaster Roaming”, as depicted in step 406. As depicted in step 408, if the value of the indication is 0 (00), then the disaster roaming managing module 304 shall disable the disaster roaming service and shall not perform disaster roaming during the disaster situation. As depicted in step 410, if the value of the indication is 1 (01), then the Disaster Roaming is enabled only if the disaster roaming managing module 304 determines that the PLMN with the disaster condition (PLMN-D) is either the HPLMN or the EHPLMN or any of the PLMN(s) in the EHPLMN list of the UE 300. When the disaster roaming managing module 304 determines that the disaster situation has occurred, the disaster roaming managing module 304 shall perform disaster roaming registration only if the UE 300 determines that the PLMN with the disaster condition (PLMN-D) is either the HPLMN or the EHPLMN or any of the PLMN(s) in the EHPLMN list of the UE 300.

As depicted in step 412, if the value of the indication is 2 (10), then the Disaster Roaming is enabled only if the disaster roaming managing module 304 determines that the MCC of the PLMN with the disaster condition (PLMN-D) is same as the MCC of either the HPLMN or the EHPLMN or any of the PLMN(s) in the EHPLMN list of the UE 300 i.e., when the UE 300 has faced disaster in the same country of the HPLMN/EHPLMN. When the disaster roaming managing module 304 determines that the disaster situation has occurred, the disaster roaming managing module 304 shall perform disaster roaming registration only if the UE 300 determines that the MCC of the PLMN with the disaster condition (PLMN-D) is same as the MCC of either the HPLMN or the EHPLMN or any of the PLMN(s) in the EHPLMN list of the UE 300. As depicted in step 414, if the value of the indication is 3 (11), then the disaster roaming managing module 304 shall enable Disaster Roaming (for any UE location or for any PLMN determined by the UE 300 as the PLMN with the disaster situation (i.e., for any PLMN-D)). When the disaster roaming managing module 304 determines that the disaster situation has occurred, the disaster roaming managing module 304 shall perform disaster roaming registration to get disaster roaming services.

The various actions in method 400 may be performed in the order presented, in a different order or simultaneously. Further, in some embodiments, some actions listed in FIG. 4 may be omitted.

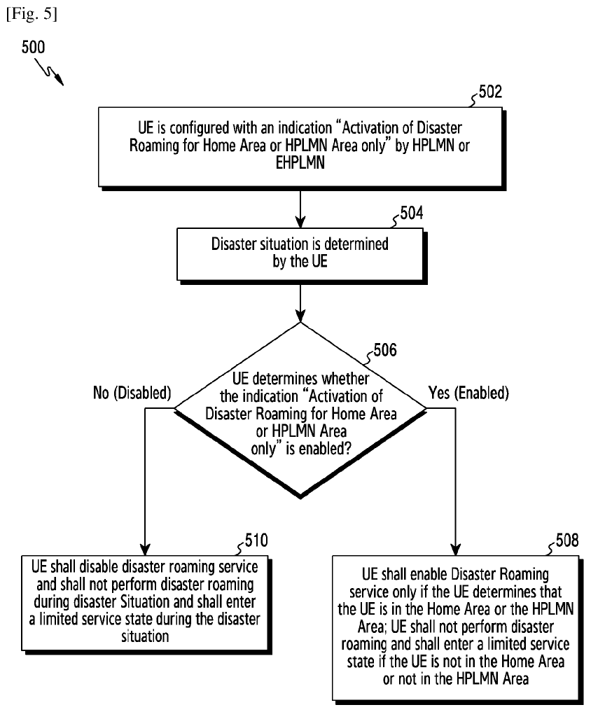

FIG. 5 illustrates a method 500 to selectively control (enable/disable) Disaster Roaming services for the UE 300 based on location of the disaster (Home Area/Roaming Area) or based on the PLMN with the disaster condition (PLMN-D). As depicted in step 502, the UE 300 is configured with an indication “Activation of Disaster Roaming for Home Area or HPLMN Area only” by the HPLMN or the EHPLMN using one of a registration procedure, a UPU procedure and a downlink (DL) NAS transport procedure. The indication is configured by using the disaster configuration module 302.

Later, a disaster situation is determined by the disaster roaming managing module 304 of the UE 300, as depicted in step 504. Thereafter, the disaster roaming managing module 304 determines whether the indication “Activation of Disaster Roaming for Home Area or HPLMN Area only” is enabled, as depicted in step 506. If the indication is enabled, then the Disaster Roaming service is enabled only if the disaster roaming managing module 304 determines that the UE 300 is in the Home Area or the HPLMN Area, as depicted in step 508. When the disaster roaming managing module 304 determines that the disaster situation has occurred, the disaster roaming managing module 304 shall perform disaster roaming registration only if the UE 300 is in the Home Area or the HPLMN Area. The disaster roaming managing module 304 shall not perform disaster roaming during disaster situation and shall enter the limited service state if the UE 300 determines that UE 300 is not in the Home Area or not in the HPLMN Area and if the value of the indication “Activation of Disaster Roaming for Home Area or HPLMN Area only” is determined/stored as enabled or TRUE.

If the indication is disabled, then the disaster roaming managing module 304 shall disable the disaster roaming service and shall not perform disaster roaming during disaster situation, as depicted in step 510. The UE 300 shall enter the limited service state during the disaster situation, in response to determining that the disaster roaming is disabled in the UE 300.

The various actions in method 500 may be performed in the order presented, in a different order or simultaneously. Further, in some embodiments, some actions listed in FIG. 5 may be omitted.

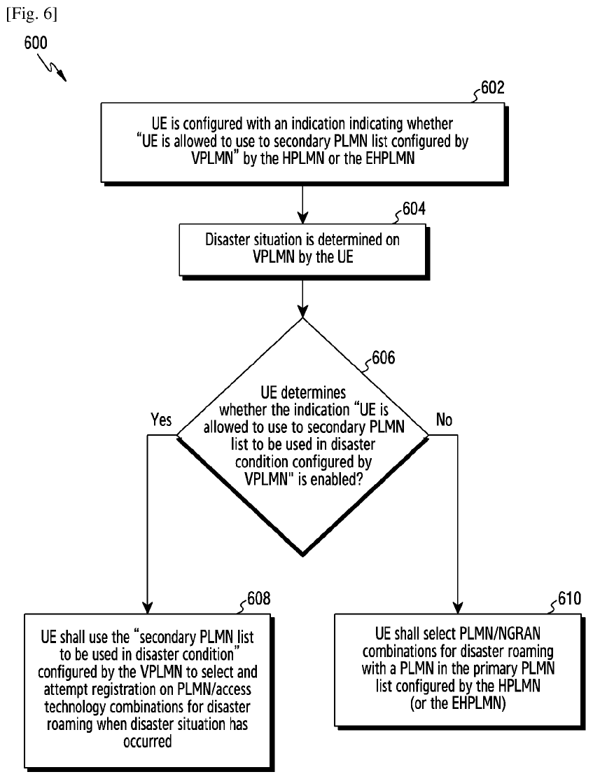

FIG. 6 depicts a method 600 by which the disaster roaming managing module 304 of the UE 300 selects and attempts registration with a PLMN for disaster roaming service in a disaster situation when the primary PLMN list configured by the HPLMN/EHPLMN is different from the secondary PLMN list configured by the VPLMN. As depicted in step 602, the UE 300 is configured with an indication indicating whether “UE is allowed to use to secondary PLMN list configured by the VLPMN” by the HPLMN or the EHPLMN by a Non-Access Stratum (NAS) procedure using one of a registration procedure, a UE Parameters Update (UPU) procedure and downlink (DL) NAS transport procedure. The indication is configured by using the disaster configuration module 302.

Later, a disaster situation is determined on the VPLMN by the disaster roaming managing module 304 of the UE 300, as depicted in step 604. On a disaster situation being determined by the UE 300 (for example, for the VPLMN), the disaster roaming managing module 304 determines whether the indication “UE is allowed to use to secondary PLMN list to be used in disaster condition′ configured by VPLMN” is enabled (also called as set to TRUE), as depicted in step 606. If the indication “UE is allowed to use to secondary PLMN list to be used in disaster condition′ configured by VPLMN” is enabled (also called as set to TRUE), the disaster roaming managing module 304 shall prefer or use the secondary PLMN list configured by the VPLMN, as depicted in step 608, to select and attempt registration on PLMN/NG-RAN combination for disaster roaming.

If the indication “UE is allowed to use to secondary PLMN list to be used in disaster condition′ configured by VPLMN” is not enabled (also called as set to FALSE), the disaster roaming managing module 304 shall select PLMN/NG-RAN combination for disaster roaming with a PLMN in the primary PLMN list configured by the HPLMN (or the EHPLMN), as depicted in step 610, wherein the PLMN list has been ordered based on the primary PLMN list configured by the HPLMN (or the EHPLMN). The disaster roaming managing module 304 shall ignore the secondary PLMN list configured by the VPLMN (if available) and select PLMN/NG-RAN combination for other forbidden PLMNs for disaster roaming, in random order.

The various actions in method 600 may be performed in the order presented, in a different order or simultaneously. Further, in some embodiments, some actions listed in FIG. 6 may be omitted.

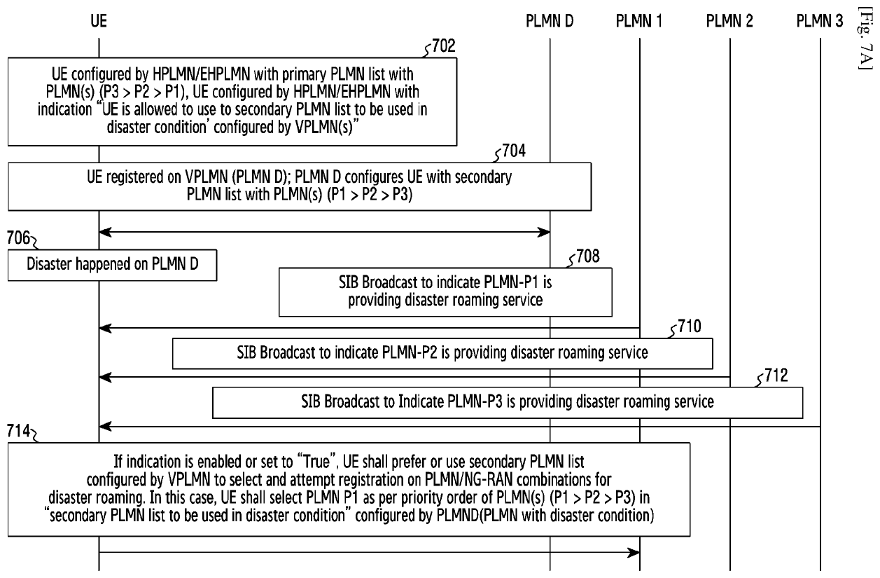

FIGS. 7A and 7B illustrate sequence diagrams depicting an example process by which the UE 300 selects and attempts registration with a PLMN for disaster roaming service in a disaster situation when the primary PLMN list configured by HPLMN/EHPLMN is different from the secondary PLMN list configured by VPLMN. As depicted in step 702, the UE 300 is configured by HPLMN/EHPLMN with primary PLMN list with PLMN(s) (P3>P2>P1). The UE 300 is also configured by the HPLMN/EHPLMN with an indication indicating whether “UE is allowed to use to ‘secondary PLMN list to be used in disaster condition’ configured by VPLMN” using one of a registration procedure and a UE configuration update procedure over a 3GPP access or a non-3GPP access.

The UE 300 is registered on a VPLMN i.e., PLMN D, as depicted in step 704, where PLMN D configures the UE 300 with the secondary PLMN list with PLMN(s) (P1>P2>P3). Consider that a disaster has happened on PLMN D, as depicted in step 706. The PLMN P1, PLMN P2 and PLMN P3 perform a System Information Blocks (SIB) Broadcast to indicate PLMN P1, PLMN P2 and PLMN P3 respectively are providing disaster roaming service, as depicted in steps 708, 710, and 712.

As depicted in FIG. 7A, if the indication is enabled or set to “TRUE”, the UE 300 shall prefer or use the secondary PLMN list configured by the PLMN (apart from the HPLMN or the EHPLMN) on which disaster condition is determined (for example, VPLMN), as depicted in step 714, to select and attempt registration on PLMN/NG-RAN combination for disaster roaming when disaster situation has occurred. In this case, the UE 300 shall select PLMN P1 as per priority order of PLMN(s) (P1>P2>P3) in secondary PLMN list configured by the PLMN-D.

As depicted in FIG. 7B, if the indication is either not present in the UE 300 (in USIM or ME) or is not configured by the HPLMN (or the EHPLMN) in the UE 300 or is disabled or is indicated as FALSE, the UE 300 shall select PLMN/NG-RAN combination for disaster roaming with a PLMN in the primary PLMN list configured by the HPLMN (or the EHPLMN), wherein the PLMN list has been ordered based on the primary PLMN list configured by the HPLMN (or the EHPLMN), as depicted in step 716. The UE 300 shall ignore the secondary PLMN list configured by the VPLMN (if available) and select PLMN/NG-RAN combination for other forbidden PLMNs for disaster roaming, in random order. In this case, the UE 300 shall select PLMN P3 as per priority order of PLMN(s) (P3>P2>P1) in “list of PLMN(s) to be used in disaster condition” configured by HPLMN.

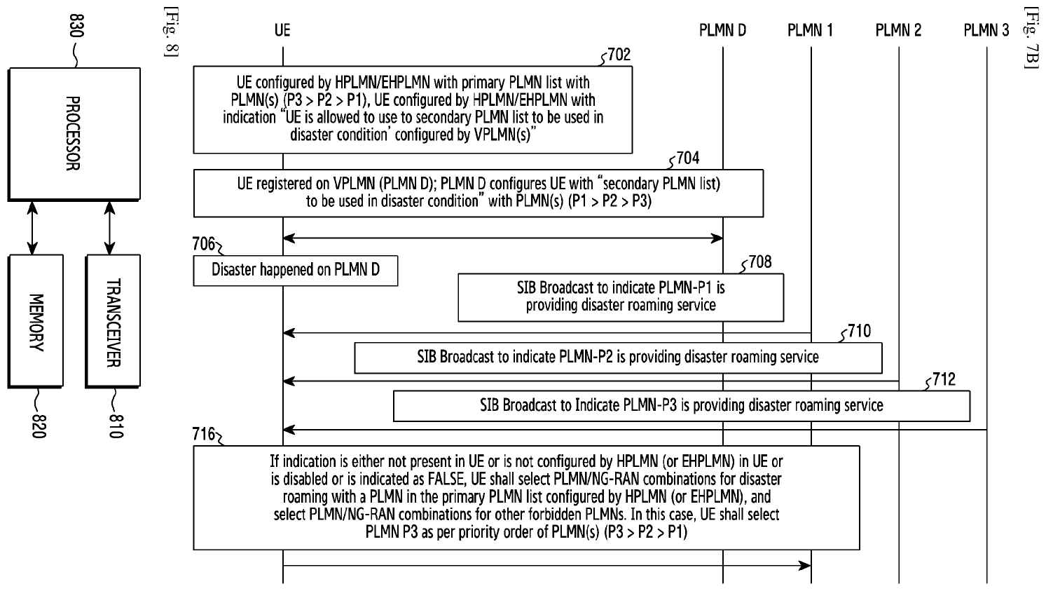

FIG. 8 is a block diagram of an internal configuration of a UE, according to an embodiment.

As shown in FIG. 8, the UE according to an embodiment may include a transceiver 810, a memory 820, and a processor 830. The transceiver 810, the memory 820, and the processor 830 of the UE may operate according to a communication method of the UE described above. However, the components of the UE are not limited thereto. For example, the UE may include more or fewer components than those described above. In addition, the processor 830, the transceiver 810, and the memory 820 may be implemented as a single chip. Also, the processor 830 may include at least one processor.

Furthermore, the UE may correspond to UE 300 of FIG. 3, the processor 830 may correspond to processor 306 of FIG. 3, the transceiver 810 may correspond to communication module 308 of FIG. 3 and the memory 820 may correspond to memory module 310 of FIG. 3.

The transceiver 810 collectively refers to a UE receiver and a UE transmitter, and may transmit/receive a signal to/from a base station or a network entity. The signal transmitted or received to or from the base station or a network entity may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the UE. Also, the memory 820 may store control information or data included in a signal obtained by the UE. The memory 820 may be a storage medium, such as read-only memory (ROM), random access memory (RAM), a hard disk, a CD-ROM, and a DVD, or a combination of storage media.

The processor 830 may control a series of processes such that the UE operates as described above. For example, the transceiver 810 may receive a data signal including a control signal transmitted by the base station or the network entity, and the processor 830 may determine a result of receiving the control signal and the data signal transmitted by the base station or the network entity.

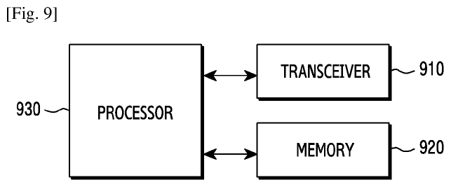

FIG. 9 is a block diagram of an internal configuration of a base station, according to an embodiment.

As shown in FIG. 9, the base station according to an embodiment may include a transceiver 910, a memory 920, and a processor 930. The transceiver 910, the memory 920, and the processor 930 of the base station may operate according to a communication method of the base station described above. However, the components of the base station are not limited thereto. For example, the base station may include more or fewer components than those described above. In addition, the processor 930, the transceiver 910, and the memory 920 may be implemented as a single chip. Also, the processor 930 may include at least one processor. Furthermore, the base station may correspond to PLMN.

The transceiver 910 collectively refers to a base station receiver and a base station transmitter, and may transmit/receive a signal to/from a terminal or a network entity. The signal transmitted or received to or from the terminal or a network entity may include control information and data. The transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the base station. Also, the memory 920 may store control information or data included in a signal obtained by the base station. The memory 920 may be a storage medium, such as read-only memory (ROM), random access memory (RAM), a hard disk, a CD-ROM, and a DVD, or a combination of storage media.

The processor 930 may control a series of processes such that the base station operates as described above. For example, the transceiver 910 may receive a data signal including a control signal transmitted by the terminal, and the processor 930 may determine a result of receiving the control signal and the data signal transmitted by the terminal.

Accordingly, the embodiment herein is to provide a method for selecting at least one Forbidden Public Land Mobile Networks (FPLMN) by a User Equipment (UE) 300 for disaster roaming, comprising: receiving, by the UE 300, a primary PLMN list and at least one secondary PLMN list to be used in a disaster condition; receiving, by the UE 300, an indication for indicating whether the UE 300 is allowed to use the at least one secondary PLMN list in the disaster condition, wherein the indication is configured by a Home PLMN (HPLMN) or an Equivalent HPLMN (EHPLMN); and selecting, by the UE 300, the at least one FPLMN/Next Generation-Radio Access Network (NG-RAN) combination from one of the primary PLMN list and the at least one secondary PLMN list based on the received indication.

In an embodiment, wherein the method discloses configuring the primary PLMN list, the at least one secondary PLMN list and the indication in one of a Universal Subscriber Identity Module (USIM) and a mobile equipment (ME) of the UE 300.

In an embodiment, wherein the method discloses configuring the primary PLMN list and the at least one secondary PLMN list using one of a registration procedure and a UE configuration update procedure over a 3GPP access or a non-3GPP access.

In an embodiment, wherein the method discloses configuring the indication by a Non-Access Stratum (NAS) procedure using one of a registration procedure, a UE Parameters Update (UPU) procedure and downlink (DL) NAS transport procedure.

In an embodiment, wherein the method discloses: determining, by the UE 300, that the disaster condition has occurred; determining, by the UE 300, a PLMN with the disaster condition; determining, by the UE 300, the indication is set to true; selecting, by the UE 300, the at least one FPLMN/NG-RAN combination for disaster roaming from the at least one secondary PLMN list associated with a PLMN ID of the determined PLMN with the disaster condition, ordered based on the at least one secondary PLMN list in response to determining that indication is set to true; and selecting, by the UE 300, the at least one FPLMN/NG-RAN combination for disaster roaming from the primary PLMN list associated with a PLMN ID of the HPLMN or the EHPLMN, ordered based on the primary PLMN list in response to determining that the at least one secondary PLMN list associated with the PLMN ID of the determined PLMN with the disaster condition is not configured.

In an embodiment, wherein the method discloses: determining, by the UE 300, that the disaster condition has occurred; determining, by the UE 300, the indication is set to false; and selecting, by the UE 300, the at least one FPLMN/NG-RAN combination for disaster roaming from the primary PLMN list associated with the PLMN ID of the HPLMN or the EHPLMN, ordered based on the primary PLMN list in response to determining that the indication is set to false.

In an embodiment, wherein the indication received, by the UE 300, is an indication of applicability of at least one list of PLMN(s) to be used in the disaster condition provided by at least one Visited PLMN (VPLMN).

In an embodiment, wherein the primary PLMN list is at least one list of PLMN(s) to be used in the disaster condition stored in the ME, wherein the at least one list of PLMN(s) of the primary PLMN list is associated with the PLMN ID of the HPLMN or the EHPLMN configured by the HPLMN or the EHPLMN in the UE 300 respectively.

In an embodiment, wherein the at least one secondary PLMN list is at least one list of PLMN(s) to be used in the disaster condition, wherein the at least one list of PLMN(s) of the at least one secondary PLMN list is associated with the PLMN ID of the at least one VPLMN configured by the at least one VPLMN in the UE 300.

Accordingly, the embodiment herein is to provide a User Equipment (UE) 300 configured to: receive a primary PLMN list and at least one secondary PLMN list to be used in a disaster condition; receive an indication for indicating whether the UE 300 is allowed to use the at least one secondary PLMN list in the disaster condition, wherein the indication is configured by a Home PLMN (HPLMN) or an Equivalent HPLMN (EHPLMN); and select at least one FPLMN/Next Generation-Radio Access Network (NG-RAN) combination from one of the primary PLMN list and the at least one secondary PLMN list based on the received indication.

In an embodiment, wherein the primary PLMN list, the at least one secondary PLMN list and the indication are configured in one of a Universal Subscriber Identity Module (USIM) and a mobile equipment (ME) of the UE 300.

In an embodiment, wherein the primary PLMN list and the at least one secondary PLMN list are configured using one of a registration procedure and a UE configuration update procedure over a 3GPP access or a non-3GPP access.

In an embodiment, wherein the indication is configured by a Non-Access Stratum (NAS) procedure using one of a registration procedure, a UE Parameters Update (UPU) procedure and downlink (DL) NAS transport procedure.

In an embodiment, wherein the UE 300 configured to: determine, by the UE 300, that the disaster condition has occurred; determine, by the UE 300, a PLMN with the disaster condition; determine, by the UE 300, the indication is set to true; select, by the UE 300, the at least one FPLMN/NG-RAN combination for disaster roaming from the at least one secondary PLMN list associated with a PLMN ID of the determined PLMN with the disaster condition, ordered based on the at least one secondary PLMN list in response to determining that indication is set to true; and select, by the UE 300, the at least one FPLMN/NG-RAN combination for disaster roaming from the primary PLMN list associated with the PLMN ID of the HPLMN or the EHPLMN, ordered based on the primary PLMN list in response to determining that the at least one secondary PLMN list associated with the PLMN ID of the determined PLMN with the disaster condition is not configured.

In an embodiment, wherein the UE 300 configured to: determine, by the UE 300, that the disaster condition has occurred; determine, by the UE 300, the indication is set to false; and select, by the UE 300, the at least one FPLMN/NG-RAN combination for disaster roaming from the primary PLMN list associated with a PLMN ID of the HPLMN or the EHPLMN, ordered based on the primary PLMN list in response to determining that the indication is set to false.

In an embodiment, wherein the indication received, by the UE 300, is an indication of applicability of at least one list of PLMN(s) to be used in the disaster condition provided by at least one Visited PLMN (VPLMN).

In an embodiment, wherein the primary PLMN list is at least one list of PLMN(s) to be used in the disaster condition stored in the ME, wherein the at least one list of PLMN(s) of the primary PLMN list is associated with the PLMN ID of the HPLMN or the EHPLMN configured by the HPLMN or the EHPLMN in the UE 300 respectively.

In an embodiment, wherein the at least one secondary PLMN list is at least one list of PLMN(s) to be used in the disaster condition, wherein the at least one list of PLMN(s) of the at least one secondary PLMN list is associated with the PLMN ID of the at least one VPLMN configured by the at least one VPLMN in the UE 300.

The embodiments disclosed herein can be implemented through at least one software program running on at least one hardware device. The modules shown in FIG. 3 include blocks which can be at least one of a hardware device, or a combination of hardware device and software module.

The embodiment disclosed herein describes a UE 300 and methods for managing disaster roaming services during Minimization of Service Interruption (MINT) situations. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the spirit and scope of the embodiments as described herein.

1-15. (canceled)

16. A method performed by a user equipment (UE) in a wireless communication system, the method comprising:
identifying a first list of public land mobile networks (PLMNs) for disaster condition associated with a home public land mobile network (HPLMN) and an indication on applicability of a second list of PLMNs for the disaster condition from a visited public land mobile network (VPLMN);
receiving, from a first base station associated with the VPLMN, the second list of PLMNs for the disaster condition; and
selecting a PLMN based on the disaster condition.

17. The method of claim 16, wherein, in case that the indication is set to true, the PLMN is selected from the second list.

18. The method of claim 17, wherein, in case that the indication is set to false, the PLMN is selected from the first list.

19. The method of claim 16, wherein at least one of the first list of PLMNs for disaster condition associated with the HPLMN or the indication on applicability of the second list of PLMNs for the disaster condition from the VPLMN is preconfigured in a universal subscriber identity module (USIM).

20. The method of claim 16, wherein at least one of the first list of PLMNs for disaster condition associated with the HPLMN or the indication on applicability of the second list of PLMNs for the disaster condition from the VPLMN is received from a second base station associated with the HPLMN.

21. The method of claim 16, wherein the first list is associated with a PLMN identifier (ID), and
wherein PLMNs are listed in the first list based on a priority.

22. The method of claim 16, wherein the second list is associated with a PLMN identifier (ID), and
wherein PLMNs are listed in the second list based on a priority.

23. The method of claim 16, wherein the indication on applicability of the second list of PLMNs for the disaster condition is configured based on at least one of a UE parameter update procedure or a downlink NAS transport procedure.

24. The method of claim 16, wherein, in case that new indication on applicability of the second list of PLMNs for the disaster condition is received, the indication on applicability of the second list of PLMNs for the disaster condition is changed.

25. The method of claim 17, wherein, in case that the second list of PLMNs for the disaster condition is not available, the PLMN is selected from the first list.

26. A user equipment (UE) in a wireless communication system, the UE comprising:
a transceiver;
a controller coupled with the transceiver and configured to:
identify a first list of public land mobile networks (PLMNs) for disaster condition associated with a home public land mobile network (HPLMN) and an indication on applicability of a second list of PLMNs for the disaster condition from a visited public land mobile network (VPLMN);
receive, from a first base station associated with the VPLMN, the second list of PLMNs for the disaster condition; and
select a PLMN based on the disaster condition.

27. The UE of claim 26, wherein, in case that the indication is set to true, the PLMN is selected from the second list.

28. The UE of claim 27, wherein, in case that the indication is set to false, the PLMN is selected from the first list.

29. The UE of claim 26, wherein at least one of the first list of PLMNs for the disaster condition or the indication on applicability of the second list of PLMNs for the disaster condition is configured in a universal subscriber identity module (USIM).

30. The UE of claim 26, wherein at least one of the first list of PLMNs for disaster condition associated with the HPLMN or the indication on applicability of the second list of PLMNs for the disaster condition from the VPLMN is received from a second base station associated with the HPLMN.

31. The UE of claim 26, wherein the first list is associated with a PLMN identifier (ID), and
wherein PLMNs are listed in the first list based on a priority,

32. The UE of claim 26, wherein the second list is associated with a PLMN identifier (ID), and
wherein PLMNs are listed in the second list based on a priority.

33. The UE of claim 26, wherein the indication on applicability of the second list of PLMNs for the disaster condition is configured based on at least one of a UE parameter update procedure or a downlink NAS transport procedure.

34. The UE of claim 26, wherein, in case that new indication on applicability of the second list of PLMNs for the disaster condition is received, the indication on applicability of the second list of PLMNs for the disaster condition is changed.

35. The UE of claim 27, wherein, in case that the second list of PLMNs for the disaster condition is not available, the PLMN is selected from the first list.
